(19) United States
(12) Patent Application Publication
(10) Pub. No.: US 2026/0146447 A1
(43) Pub. Date: May 28, 2026

(54) COMPOSITE WALL PANELS HAVING A POLYMER FINISH LAYER AND METHOD OF MANUFACTURE

(71) Applicant: HYDROBLOK, INC., Park City, UT (US)

(72) Inventors: Zhongsheng CHEN, Draper, UT (US); Brian DUNN, Draper, UT (US); Alex GILLESPIE, Draper, UT (US)

(21) Appl. No.: 19/343,601

(22) Filed: Sep. 29, 2025

Related U.S. Application Data
(60) Provisional application No. 63/703,834, filed on Oct. 4, 2024.

(51) Int. Cl. E04B 2/00; B32B 3/26; B32B 5/02; B32B 5/18; B32B 5/24; B32B 13/02; B32B 13/04; B32B 13/12; B32B 27/30; C04B 14/30; C04B 16/04; C04B 28/18; C04B 103/30; C04B 103/50; C04B 111/00; C08J 9/36; C09D 133/04; C09D 175/02; E04C 2/288; E04C 2/296

(52) U.S. Cl. CPC E04C 2/46; B32B 3/263; B32B 5/02; B32B 5/18; B32B 5/245; B32B 13/02; B32B 13/045; B32B 13/12; B32B 27/308; C04B 14/308; C04B 16/04; C04B 28/18; C08J 9/365; C09D 133/04; C09D 175/02; E04C 2/288; E04C 2/296; B32B 2250/04; B32B 2262/10; B32B 2266/02; B32B 2266/04; B32B 2307/7376; B32B 2607/00; C04B 2103/302; C04B 2103/50; C04B 2111/00612; C08J 2433/04; C08J 2475/02

(57) ABSTRACT

Composite wall panels, compositions used to make composite wall panels, and methods for manufacturing composite wall panels. Composite wall panels include a core composite panel structure and a finish layer at least partially covering at least one side of the core composite panel structure. The core composite panel structure includes a foam core sandwiched between thin protective layers (e.g., fiber mesh reinforced cementitious layer, thermoset polymer layer, and/or magnesium oxide layer). The finish layer can be light-cured, UV-cured, and/or chemical-cured resin that forms a polymer layer. The composite wall panels can be used to replace gypsum drywall panels and are advantageously lighter weight, have beveled edges, and can have a smooth or textured finish layer. The composite wall panels can be cut, drilled, and screwed onto structural elements of buildings, such as wall frames comprising wooden or metal studs or ceiling joists.

### CROSS-REFERENCE TO RELATED APPLICATION

This application claims the benefit of U.S. Provisional Application No. 63/788,276, filed Apr. 14, 2025, and U.S. Provisional Application No. 63/703,834, filed Oct. 4, 2024, which are incorporated by reference in their entirety.

### BACKGROUND

### Technical Field

This disclosure relates to composite wall panels with a polymer finish layer, particularly composite wall panels that can substitute for gypsum drywall, and compositions and methods for making composite wall panels.

### Related Technology

Houses and other buildings are typically constructed using wood or metal studs to form a three-dimensional wall frame, which can include an interior wall on one side and an exterior wall on the other. Alternatively, both sides can be interior walls, such as interior walls separating rooms or walls dividing attached dwelling units such as apartments, town houses, and condominiums. Interior walls of houses and other buildings are typically formed using drywall (e.g., gypsum board) to form a generally flat underlying wall surface, which can be painted, wallpapered, or treated with other desired finishes.

Wallboard, also called drywall, is used for interior walls and ceilings in buildings and is a replacement for old fashioned lath and plaster systems. A wallboard panel typically consists of a layer of gypsum plaster (CaSO₄·2H₂O) sandwiched between two layers of paper. The raw gypsum, CaSO₄·2H₂O, is heated to drive off the water and then slightly rehydrated to produce calcium sulfate hemihydrate (CaSO₄·½H₂O) plaster, also known as plaster of Paris. The plaster is mixed with fiber (typically paper and/or glass fiber), plasticizer, foaming agent, finely ground gypsum crystal as an accelerator, EDTA, starch or other chelate as a retarder, and various additives that can increase mildew and fire resistance, lower water absorption (wax emulsion or silanes), and reduce creep (tartaric or boric acid). The board is then formed by sandwiching a core of the wet mixture between two sheets of heavy paper or fiberglass mats. When the core sets, it is dried in a large drying chamber, and the sandwich becomes rigid and strong enough for use as a building material.

As an alternative to a week-long plaster application, an entire house can be drywalled in one or two days by experienced drywallers and even amateur home carpenters. Joints between drywall panels are typically covered with tape and a thin layer of drywall patch. Special finishes can be applied for texture, and the drywall is typically primed and painted and/or wallpapered to yield a finished.

Gypsum drywall is not water resistant and is not recommended for applications where it is exposed to water and high humidity environments. Although interior drywall is typically not intended to be exposed to water, accidents can occur, such as a broken water pipe. Water can irreversibly damage gypsum drywall, requiring tear-out and replacement following water damage. Gypsum drywall is highly vulnerable to moisture due to the inherent properties of the materials that constitute it: gypsum, paper, and organic additives and binders. Gypsum will soften with exposure to moisture and eventually turn into a gooey paste with prolonged immersion, such as during a flood or even in a bathroom when exposed to excessive water. Following water damage, some or all of the drywall will likely need to be removed and replaced. Furthermore, the paper facings and organic additives mixed with the gypsum core can promote mold growth, which is both unsightly and unhealthy.

Another issue is fire and thermal resistance. While gypsum drywall can provide a level of fire and heat resistance, multiple layers or thick assemblies are often required, increasing weight, material use, cost and labor. Gypsum-based panels are highly susceptible to water damage, mold growth, and structural degradation in high-humidity environments or areas prone to water leaks. Gypsum-based shaft liners offer limited thermal resistance, reducing energy efficiency in walls exposed to external temperature differentials.

Another issue with gypsum board is the outer surface is paper, which appears unfinished and requires application thereto of one more finishing layers, such as paint and/or wallpaper. While paint and wallpaper can readily adhere to the paper surface of gypsum board, some builders and homeowners will apply a thin plaster coating layer (e.g., skim coat) over the paper layer to reinforce the drywall and provide a more even and durable surface to which a finish can be applied.

Another issue with traditional gypsum wallboards is their tendency to warp, have surface imperfections, or otherwise have defects that make them non-planar. As a result, it is often necessary to “float” tile and other surface finishes using thin set mortar to yield a planar finish. In the event that a planar wall surface (e.g., “level 5” surface) is required, such as when the surface finish includes paint, wallpaper, or other pristine wall finish that may expose non-planar defects, it will typically be necessary to fill in surface defects and warping using plaster, which can be expensive and time consuming.

Accordingly, there remains a need for improved wall panels that can substitute for gypsum drywall, which are waterproof, are heat resistance, provide high strength, yet remain lightweight to facilitate installation.

### SUMMARY

Disclosed are composite wall panels and compositions and methods for manufacturing composite wall panels. The composite wall panels can be used in place of gypsum drywall for making interior walls and are advantageously strong, lightweight, and moisture and heat resistant. The composite wall panels can have a polymer finish layer (i.e., that faces away from the wall frame) having a desired surface finish, such as smooth or textured.

The composite wall panels comprise a core composite panel structure over which a polymer finish layer has been applied. The core composite panel structure comprises a lightweight foam core sandwiched between first and second protective layers, such as a fiber mesh reinforced cementitious composition and/or cured thermoset resin or other rigid material. The polymer finish layer (e.g., a light-cured resin, UV-cured resin, or chemical-cured resin) can be formed over one or both sides of the core composite panel structure to yield composite wall panels of desired construction and functionality.

The composite wall panels can be used to form interior wall structures. In some embodiments, the outer/exposed surface of the core composite panel structure and optionally the side edges can be covered by the polymer finish layer. The interior surface of the composite wall panel (i.e., that faces inwardly) can omit a polymer finish layer and have a textured surface that facilitates the use of glue or other adhesives to attach composite wall panels to structural elements of a building, such as interior wall studs or ceiling joists.

The composite wall panels can be cut, drilled, screwed, or glued onto structural elements of buildings, such as interior wall studs or ceiling joists. The composite wall panels are advantageously lightweight yet strong and able to support relatively heavy loads, such as pictures or other items attached using nails or other hangers or wall-mounted televisions attached using screws or other wall attachment systems. The composite wall panels can be moisture-resistant (e.g., waterproof) and heat-resistant (e.g., fire resistant), and have high structural strength (e.g., high tensile strength, flexural strength, and/or toughness).

Because the core composite panel structure comprises a strong lightweight foam core sandwiched between two fiber mesh reinforced cementitious (or other rigid protective) layers, and because the polymer finish layer applied to the core composite panel structure can be thin and lightweight, the composite wall panels disclosed herein are both lighter weight and stronger than conventional gypsum drywall. Moreover, the core composite panel structure and finish layer can be waterproof, providing extra safety if the composite wall panels are inadvertently exposed to moisture. The polymer finish layer is typically formed from a curable polymer resin, such as by light, UV, and/or chemical curing, and is therefore also waterproof. The composite wall panels can also include beveled edges (e.g., 2 or 4) to permit placement of multiple adjacent composite wall panels to a wall to form beveled joints, followed by application of drywall patch (taping and mudding) to hide the beveled joints.

In some embodiments, the fiber mesh reinforced cementitious (or other rigid protective) layers of the core composite panel structure can have a grid pattern or other texture or discontinuities that may be desirably smoothed out by the polymer finish layer in order to yield composite wall panels having a smooth surface, at least on the show side that is intended to receive a subsequent finish, such as paint or wallpaper. Alternatively, the polymer finish layer can have a textured surface or other non-smooth finish to provide a desired look or functionality (e.g., old world or traditional lath and plaster look). The polymer finish layer can be formed by applying a curable composition, such as a UV curable resin or a chemical cured resin, over one or both fiber mesh reinforced cementitious (or other rigid protective) layers of the core composite panel structure.

Additional features and advantages will be set forth in part in the description that follows, and in part will be obvious from the description, or may be learned by practice of the embodiments disclosed herein. It is to be understood that both the foregoing brief summary and the following detailed description are exemplary and not restrictive of the embodiments disclosed herein or as claimed.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A is a side perspective view that illustrates examples of different sizes of core composite panel structures, which can be modified to form composite wall panels;

FIG. 1B is a top plan view photograph that illustrates the differently sized core composite panel structures of FIG. 1A;

FIG. 2 is an exploded diagram that schematically illustrates the layered structure of the core composite panel structure of FIGS. 1A and 1B;

FIG. 3 is a perspective view that illustrates an example composite wall panel, with the different layers being visible, including a textured finish layer;

FIGS. 4A-4C illustrate an example composite wall panel, with the different layers being visible, including a smooth finish layer;

FIG. 5 is a perspective view that schematically illustrates an embodiment of a composite wall panel with bevels extending to each of the four edges;

FIG. 6A is a cross-sectional view that schematically illustrates the layered structure of an embodiment of a composite wall panel with beveled edges;

FIG. 6B is an exploded diagram that schematically illustrates the layered structure of the composite wall panel of FIG. 6A;

FIG. 7A is a cross-sectional view that schematically illustrates the layered structure of another embodiment of a composite wall panel with beveled edges;

FIG. 7B is an exploded diagram that schematically illustrates the layered structure of the composite wall panel of FIG. 7A;

FIG. 8A illustrates a pair of composite wall panels abutting each other, with beveled edges forming a channel or depression that can be filled with tape and drywall patch during installation;

FIG. 8B illustrates a pair of composite wall panels abutting each other, with the beveled edges covered by drywall patch or plaster;

FIG. 9 schematically illustrates an apparatus for grinding or trimming bevels in a core composite panel structure before forming a finish layer and/or for forming bevels in the foam core prior to applying a fiberglass mesh reinforced cementitious (or other protective) layer over the beveled foam core; and

FIG. 10 illustrates an example apparatus for applying a curable polymer resin to at least one side of the core composite panel structure and then curing the curable polymer resin composition to form a polymer finish layer.

### DETAILED DESCRIPTION

### I. Overview

Disclosed are composite wall panels with polymer finish layer that are strong, lightweight, water resistant, and heat resistant. Also disclosed are compositions and methods for manufacturing the composite wall panels. The composite wall panels include a core composite panel structure comprised of a lightweight foam core sandwiched between first and second protective layers of fiber mesh reinforced cementitious composition or other rigid protective material. A polymer finish layer is formed over one or both sides of the core composite panel structure to yield composite wall panels. The finish layer is typically applied as a curable liquid resin to at least one side of the core composite panel structure and caused or allowed to cure, such as by light, UV, and/or chemical curing. The composite wall panels can be cut, drilled, and screwed, nailed, or glued onto structural elements of buildings, such as interior wall studs or ceiling joists.

### A. Core Composite Panel Structure

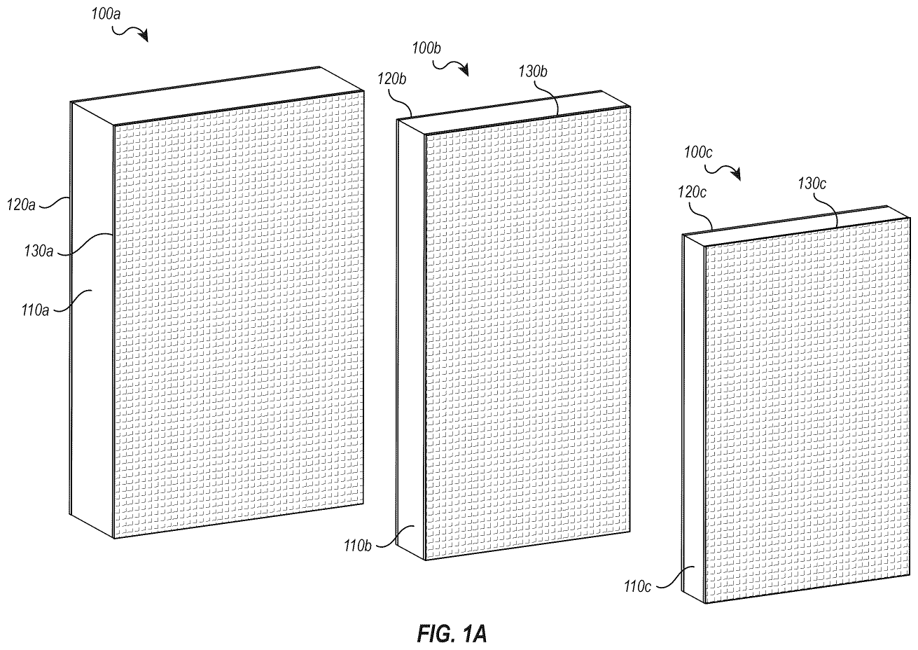

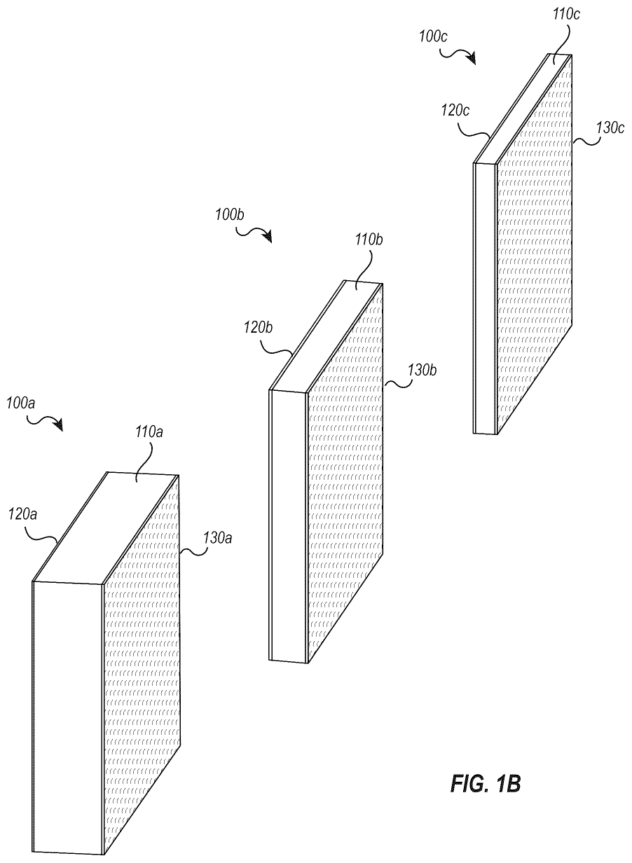

Reference is made to FIGS. 1-2. FIGS. 1A and 1B illustrate core composite panel structures 100a, 100b, 100c of varying cross-sectional thickness that can be modified by application of one or more finish layers to yield composite wall panels of the disclosure. FIGS. 1A and 1B show the layered structure of core composite panel structures 100a, 100b, 100c, including strong, lightweight, and moisture-resistant extruded polystyrene (XPS) foam cores 110a, 110b, 110c sandwiched between first fiber mesh reinforced cementitious layers 120a, 120b, 120c and second fiber mesh reinforced cementitious layers 130a, 130b, 130c. As discussed below, in other embodiments the foam core may comprise other polymer or inorganic foam materials, and one or both protective layers may comprise a thermoset polymer or other rigid protective material.

The cross-sectional thickness of the core composite panel structures 100a, 100b, 100c can be selected based on a combination of desired properties for their intended use to make composite wall panels, such as strength, insulation, spacing between wall elements and the like. As illustrated in FIGS. 1A and 1B, the cross-sectional thicknesses of the core composite panel structures 100a, 100b, 100c varies mostly or entirely depending on the cross-sectional thickness of the foam cores 110a, 110b, 110c. Although not shown, when core composite panel structures 100 of greater cross-sectional thickness are desired, it may be desirable to increase the thickness of the fiber mesh reinforced cementitious layers 120, 130 (e.g., to account for possible strength reduction caused by including a foam core 110 of greater cross sectional thickness).

FIG. 2 is in an exploded view that schematically illustrates the layered structure of a core composite panel structure 200, which is similar or identical to the core composite panel structures 100a, 100b, 100c of FIGS. 1A and 1B. The foam core 210 can be a lightweight polymer foam made from closed cell extruded polystyrene (XPS), is lightweight, rigid, waterproof, thermally insulating, and includes two outer surfaces or faces. In some embodiments, the foam core 210 may have a density of about 30-45 kg/m³ and a compressive strength of about 250-400 kPa.

Alternatively, the foam core 110, 210 can be made from a different polymer foam material, such as, but not limited to, expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. An advantage of thermoset polymer foam materials is they are generally more fire- and heat-resistant than thermoplastic polymers, with thermoset phenolic polymers in particular providing a high level of fire and heat resistance.

The properties of various polymers that can be used to make foam core layers 110, 210 are set forth in Tables 1-3.

TABLE 1

| Property | XPS/EPS | Phenolic |
|---|---|---|
| Material Type | Thermoplastic | Thermoset (phenol- |
| | polystyrene | formaldehyde) |
| Thermal Conductivity | 0.028-0.033 | 0.018-0.022 |
| (W/m · K) | | |
| R-Value per inch | ~5.0 | 6.5-7.2 |
| Fire Resistance | Poor - melts, drips | Excellent - chars, |
| | | low smoke |
| Flame Spread (ASTM E84) | 75-200 | <25 (Class A) |
| (W/O Facer | | |
| Smoke Development | >450 (often) | <50 |
| (W/O Facer) | | |
| Thermal Stability | ~93° C. (melts) | 150-175° C. |
| Water Resistance | Excellent | Good (closed-cell) |
| Compressive Strength | 200-300 kPa | 100-150 kPa |
| Flexural Strength | Flexible, good | Brittle |
| Recyclability | Yes (thermoplastic) | No |
| Weight (kg/m³) | 25-35 | 35-50 |
| Cost | Low-Moderate | High |

TABLE 2

| Property | Melamine | PUR |
|---|---|---|
| Material Type | Thermoset (melamine- | Thermoset (polyol + |
| | formaldehyde) | isocyanate) |
| Thermal Conductivity | 0.032-0.036 | 0.020-0.025 |
| (W/m · K) | | |
| R-Value per inch | ~4.1-4.5 | ~6.0-6.5 |
| Fire Resistance | Excellent - non- | Poor - needs FR |
| | melting, self- | additives |
| | extinguishing | |
| Flame Spread (ASTM E84) | <25 (Class A) | Varies (often >25) |
| (W/O Facer | | |
| Smoke Development | Very low | High |
| (W/O Facer) | | |
| Thermal Stability | ~240° C. | ~100-120° C. |
| Water Resistance | Poor unless sealed | Good |
| Compressive Strength | Low | 150-300 kPa |
| Flexural Strength | Very brittle | Strong |
| Recyclability | Limited | No |
| Weight (kg/m³) | 7-12 | 30-45 |
| Cost | High | Moderate |

TABLE 3

| Property | Polyiso |
|---|---|
| Material Type | Thermoset (polyisocyanurate) |
| Thermal Conductivity | 0.020-0.023 |
| (W/m · K) | |
| R-Value per inch | ~6.0-6.5 |
| Fire Resistance | Good - chars, often Class A |
| | with facer |
| Flame Spread (ASTM E84) | <25 (Class A with facer) |
| (W/O Facer | |
| Smoke Development | <150 |
| (W/O Facer) | |
| Thermal Stability | ~150° C. |
| Water Resistance | Fair (can degrade if |
| | unprotected) |
| Compressive Strength | 140-200 kPa |
| Flexural Strength | Moderate |
| Recyclability | Rarely recycled |
| Weight (kg/m³) | 30-42 |
| Cost | Moderate-High |

With reference to FIG. 2, formed over first and second outer surfaces of the foam core 210 are first and second layers of fiber (e.g., fiberglass) mesh 220b, 230b, respectively, which become embedded within respective first and second layers of fresh cementitious composition applied over the fiber mesh layers 220b, 230b, which harden or cure to form first and second cementitious layers 220a, 230a. Together, the hardened cementitious layers 220a, 230a and embedded fiberglass mesh layers 220b, 230b form first and second fiber mesh reinforced cementitious layers 220, 230, which adhere to the foam core 210 to form a strong but lightweight core composite panel structure. The fiber mesh layers 220b, 230b can alternatively include other fibers or filaments, such as carbon fibers or filaments.

The lightweight foam core is typically made from extruded polystyrene foam (XPS), but can alternately comprise expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. The lightweight foam core can be made of closed cell polystyrene foam to provide a water-resistant barrier (e.g., 100% waterproof).

Alternatively, the foam core may comprise an inorganic foam, such as a refractory foam material, to provide additional fire-resistance. Examples include silica gel, aerogel, silicate foams (e.g., that include or are derived from silicate-rich minerals, such as perlite, spherical perlite, and vermiculite), urea-silicate foam, SiOC/SiC, ceramic foams, refractory foams, and the like. The inorganic foam core can resist melting even when exposed to fire or intense heat in order for the core composite panel structure to maintain its structural integrity.

In some embodiments, the core composite panel structures are manufactured by applying a fiber (e.g., fiberglass) mesh and fresh cementitious composition onto first and second surfaces of a rigid polymer (e.g., XPS) or inorganic foam core and causing or allowing the applied cementitious composition to harden. The fiber mesh becomes embedded in the hardened cementitious layer to enhance strength, increase toughness, and prevent cracking of the hardened cementitious layer. Alternatively, at least one of the hardened cementitious layers can be replaced or augmented with a cured polymer layer.

The layers of fiber mesh reinforced cementitious composition are generally “thin” (e.g., typically less than about 3 mm, less than about 2.5 mm, less than about 2 mm, or less than about 1.5 mm, such as about 1 mm, or between about 0.5-3 mm, about 0.75-2.5 mm, about 1-2 mm, or about 1.25-1.75 mm in cross-sectional thickness). The fiber mesh reinforced cementitious layers can be very lightweight yet waterproof and have high structural strength (i.e., high tensile and flexural strength and high toughness). The fiber mesh component is typically fiberglass fiber or glass filament mesh, but can be made of other strong fibers or filaments, such as carbon fibers or filaments. In some embodiments, fiberglass mesh is formed of an alkali-resistant material and may have nominal mesh size of 4×4 mm with a strand diameter of about 0.5-1.0 mm.

In the case where it is desired for composite wall panels to have beveled edges (e.g., to accommodate mesh tape and wall patch to join adjacent composite wall panels together), the fiber mesh reinforced cementitious layer of the core composite panel structure can be applied before or after forming beveled edges in the form core when forming the core composite panel structure. To maximize strength and performance, the fiber mesh reinforced cementitious (or other rigid) layer can be applied after forming beveled edges in the foam core to create a continuous fiber mesh reinforced cementitious (or other protective) layer across the entire surface of the core composite panel structure before forming the polymer finish layer.

In some embodiments, the fresh cementitious composition comprises mixture products of water, hydraulic cement, silicon dioxide powder, calcium oxide, iron oxide, plaster of Paris (gypsum hemihydrate), water-reducing agent, defoamer, styrene, and acrylic acid. The fresh cementitious composition may optionally include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The cementitious composition may include other components, such as natural hydraulic lime, calcium silicate, and/or expanded glass, which can increase fire and heat resistance

In a more particular embodiment, the cementitious composition applied to the outer surfaces of the foam core to form fiber mesh reinforced cementitious layers of the core composite panel structures can be formed by mixing together the following components (expressed in weight percent) to form a fresh flowable cementitious composition, which is applied to the foam core surfaces, together with fiber mesh, and then allowed to harden or cure:

| | |
|---|---|
| Hydraulic cement | 30-50% |
| Silicon dioxide | 40-60% |
| Calcium oxide | 2-5% |
| Iron oxide | 0.2-1% |
| Gypsum hemihydrate | 3-8% |
| Water-reducing agent | 0.2-0.6% |
| Defoamer | 0.2-0.6% |
| Styrene | 1-2% |
| Acrylic acid | 1-2% |
| Water | (15-22%, or 16-20%, preferably 18.4% |
| | of dry ingredients above) |

The hydraulic cement typically includes Portland cement clinker interground with gypsum for set control, but may also include other interground minerals, such as limestone filler (e.g., 5-10% by weight of the hydraulic cement), and optionally one or more supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The silicon dioxide can be 150 mesh ground quartz sand. The water reducer can be a low-range water reducer, such as a compound of carboxylic acid grafted multi-polymer and other effective additives. The defoamer can reduce the surface tension of water, solution, suspension, etc., prevent the formation of foam, or reduce or eliminate the original foam. The main component of the defoamer defoamer can be polydimethylsiloxane (Me₃SiO(Me₂SiO)nSiMe₃)(Me=methyl). In the case where very fine SCMs (e.g., silica fume, microsilica, or metakaoline), it may be desirable to use a high range water reducer (e.g., polycarboxylate ether) to obtain good flow. The styrene and acrylic acid components, which may be a copolymer, can form a chemical bond to the extruded polystyrene foam core, in addition to the physical bond.

The components of the cementitious composition can be mixed by high-performance mixing equipment through precise batching, and then fed into a mixing barrel in sequence for high-speed dispersion and mixing, thus yielding a fresh cementitious mixture. The fresh cementitious mixture is blended in a tank to make it into liquid or plastic form. The liquid cementitious mixture is then pumped into a machine variously called a “waterfall machine,” commonly known as a “curtain coater” or enrobing “coater/machine”, which has flow control of the liquid cementitious mixture and which will apply the liquid cementitious mixture onto surfaces of an extruded polystyrene foam sheet or other material to be coated. The liquid cementitious mixture is applied like a waterfall or curtain through a blade applicator to evenly apply it to the polymer foam surfaces or other surface to be coated. The product is then cured and left to stand for approximately 7 days as usual practice. However, if ambient conditions are dry and hot, the curing period could be shortened to approximately 3-4 days.

In general, the hardened fiber mesh reinforced cementitious composition can adhere and bond strongly to the polymer or inorganic foam core to form a strong core composite panel structure that does not delaminate. The bond between the cementitious layers and the foam layer is likely a combination of physical and chemical interactions. When applied to the polymer or inorganic foam layer, the liquid cementitious composition can penetrate into surface pores of the foam layer, which upon hardening of the cementitious composition, forms a strong mechanical bond. This bond can be further enhanced through the inclusion of very fine pozzolans, such as silica fume, microsilica, or metakaoline on the cementitious composition, which creates a very high strength cementitious layer and are able to fill very small micropores. The polymer components of the cementitious composition may also interact with components of the foam layer to form a type of chemical bond between the cementitious layers and the foam (e.g., polymer) layer. Regardless of how bonding occurs, it is demonstrably very strong and does not delaminate during specified use. Curable resins also adhere and bond strongly to the foam core.

In some embodiments, when manufacturing the core composite panel structure, the fiberglass mesh is first laid down on a polymer (e.g., extruded polystyrene) or inorganic foam sheet. A transportation belt then transports the foam sheet with the fiberglass mesh through the waterfall machine (commonly known as a “curtain coater” or enrobing “coater/machine”), which causes the liquid cementitious mixture to flow down like a waterfall or curtain, with control of the liquid cementitious mixture flow, onto the foam sheet or other substrate. In this way, the fiberglass mesh becomes embedded in the liquid cementitious mixture and essentially floats in the middle of the cementitious mixture. In other words, a portion of the liquid cementitious mixture will be positioned between the fiberglass mesh and the foam sheet in order to directly adhere to the foam sheet, and another portion of the liquid cementitious mixture will cover and encapsulate the fiber mesh to form the top surface of the core composite tile structure. The result is a layered composite core structure, with an interior polymer or inorganic foam sheet, an underlying layer of cementitious composition in direct contact with the foam sheet, a fiberglass mesh in the middle, and a top layer of cementitious composition covering the fiberglass mesh.

In addition to, or instead of, a fiber mesh reinformed cementitious layer, one or both protective layers of the composite core panel structure may comprise other materials in addition to or instead of the cementitious composition. Examples include one or more of rigid magnesium oxide material, water-resistant polymer, or a composite material comprising a resin or polymer with embedded fibers, fiber mesh, fabric, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as a light-cured resin, UV-cured resin, or chemical-cured resin, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

Polyurea is a type of elastomer that is derived from the reaction product of an isocyanate component and an amine component. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin. The resin blend can include amine-terminated polymer resins and/or amine-terminated chain extenders. The resin blend may also contain additives or non-primary components, such as pigments pre-dispersed in a polyol carrier. Normally, the resin blend does not contain a catalyst. This is because the reaction between an isocyanate and amine is extremely fast and hence does not need catalysis.

The chemical structure of polyurea is as follows:

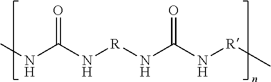

In polyurea, alternating monomer units of isocyanates and amines react with each other to form urea linkages, as shown below.

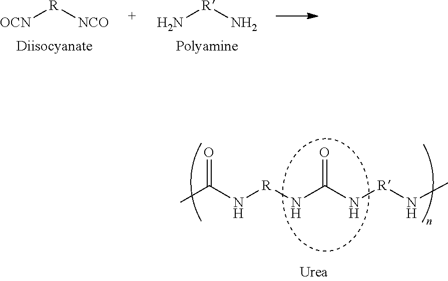

Polyaspartic resin is a solvent-free, aliphatic amine coating material based on aspartic acid, polyaspartic acid, or polyaspartic ester, which reacts with an isocyanate to create extremely durable protective coatings with rapid cure times, excellent abrasion resistance. An example of a curable polyaspartic resin has the following reactants and final cured polymer structure:

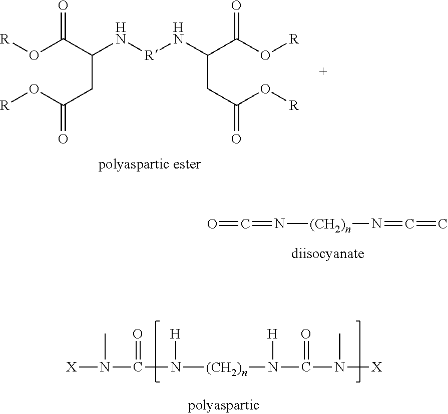

The curable resin can be applied by spray coating while in a flowable state to one or both surfaces of the foam core and allowing it to cure and form a solid protective layer. Multiple parts of the curable resin can be mixed just prior to entering or within the nozzle used to spray coat the foam core. Where it is desired to incorporate a fiberglass mesh sheet in the polymer layer, an initial coating of curable resin can be applied to the foam core, followed by applying the fiberglass mesh sheet over the resin, followed by applying a final coating of the curable resin.

In some embodiments, the outlines of the fiberglass mesh embedded within the hardened cementitious or cured resin layer can be visible and form a grid-like texture that improves adhesion of structural and/or decorative materials thereto, such as the polymer finish layer. The finish layer can hide the grid-like texture and form a smooth surface and/or be processed to form a different textured surface.

The core composite panel structures can be rectangular in shape, with a constant cross sectional thickness and essentially planar surfaces. Alternatively, the core composite panel structure can have beveled edges. Prior to forming the beveled edges, the foam core can be rectangular in shape, with a constant cross-sectional thickness. Beveled edges can be formed by cutting or grinding the sides of the foam core. The core composite panel structure can include a polymer-modified cementitious coating composition that facilitates adhesion of the cementitious coating to the interior foam core.

### B. Composite Wall Panels

In order for composite wall panels to function as an interior drywall replacement, such as where it may be desired to apply an interior finish, such as paint, wallpaper, or molding (e.g., wainscot, wood paneling, or crown molding), the core composite panel structures described herein are modified to include a polymer finish layer formed over at least one of the fiber mesh reinforced cementitious (or other protective) layers. The polymer finish layer can be generally white in color, although other colors are possible if desired.

Composite wall panels can include a light colored (e.g., white or off white) polymer finish layer formed over at least the exterior surface of the exterior fiber mesh reinforced cementitious (or other protective) layer, and optionally the side edges, giving the composite wall panels the appearance of wallboard without paper. Because composite wall panels can include fiber mesh reinforced cementitious (or other protective) layers, along with a waterproof interior polymer foam core, they are both waterproof and substantially stronger than conventional gypsum drywall. The composite wall panels can be used, for example, in embodiments where it is desired to construct a complete wall structure that includes two interior walls or, alternatively, an interior wall and an exterior wall made with composite wall panels to which an exterior finish is applied, such as in U.S. Provisional Application No. 63/744,115, filed Jan. 10, 2025, and U.S. Provisional Application No. 63/729,637, filed Dec. 9, 2024, which are incorporated by reference in their entirety. They can be used to make shaft liners, such as in U.S. Provisional Application No. 63/747,543, filed Jan. 21, 2025, which is incorporated by reference in its entirety.

The composite wall panels include a lightweight foam core sandwiched between two fiber mesh reinforced cementitious (or other protective) layers, but with an additional polymer finish layer applied on at least one protective layer to provide a polymer finish to yield wall panels that can substitute for gypsum drywall. The polymer finish layer can be textured, sanded, painted, wallpapered, and the like, similar to the surface of conventional gypsum wallboard. However, the polymer finish layer can have a desired surface finish that eliminates the requirement to apply a finish to the paper surface of conventional gypsum drywall. The composite wall panels can be attached to wood or metal studs or other wall or ceiling structural elements using screws, nails, adhesives, or other known attachment means. The composite wall panels can also include bevels (e.g., 2 or 4) to permit placement of multiple adjacent composite wall panels, followed by application of drywall patch (taping and mudding) to hide the joints. Specialized connectors, such as washers with enlarged surfaces and penetrating prongs can be used to join adjacent composite wall panels together, as disclosed in U.S. Provisional Application Nos. 63/744,115 and 63/729,637, discussed above.

The composite wall panels disclosed herein are a substantial improvement over traditional gypsum drywall boards, which are both heavy and prone to moisture damage. When exposed to moisture, gypsum drywall absorbs any surrounding water and deleterious substances and contaminants present in such moisture. Upon evaporation, deleterious remnants and contaminants can initially cling to the surrounding substrate, providing a breeding ground for mold, mildew, fungi, spores, and bacteria. Eventually, these deleterious elements and contaminants can make their way into the air, causing numerous health problems. The composite wall panels provide a solution to various problems caused by gypsum drywall.

In contrast to gypsum drywall boards, the components of the composite wall panels disclosed herein are in and of themselves waterproof naturally, with no added chemicals added or adhered to achieve water tightness. Forming the system as a sandwich of waterproof layers, including an outer finish layer, creates backup layers of waterproofing, making the core composite panel structure impervious to water, thus providing for a clean and safe surrounding environment. In flood prone areas, FEMA maps can provide geographic data where waterproof products incorporating the core composite panel structure should be used in retrofit and new construction. Traditional gypsum board becomes structurally unsound when exposed to moisture whereas composite wall panels incorporating the core composite panel structure and polymer finish layer retain full structural integrity in the presence of moisture.

Previous embodiments of interior wall panels that incorporate the core composite panel structure described above are disclosed in U.S. Provisional Application No. 63/686,489, filed Aug. 23, 2024, U.S. Provisional Application No. 63/692,563, filed Sep. 9, 2024, and U.S. Provisional Application No. 63/703,834, filed Oct. 4, 2024, incorporated by reference. These patent applications describe Generation I and Generation II composite wall panels, while the present disclosure involves Generation III composite wall panels.

The development of the composite wall panels has followed the following three-generation evolution:
Generation I features a composite wall panel that includes a plaster-like coating applied to the face or exposed surface of the core composite panel structure. While offering a durable surface, the multi-step plaster application process has challenges relating to manufacture and quality control.
Generation II replaces the plaster layer with a laminated paper surface bonded to the core composite panel structure using a UV-curable undercoat. This achieves the look and feel of traditional drywall and improved surface consistency. However, the paper layer serves mainly as a decorative skin, requiring multiple production steps (UV coating, glue, lamination, edge wrapping, and trimming) and still presents some issues with respect to beveling, bonding, and durability.
Generation III, the subject of the present disclosure, solves both sets of challenges. It eliminates the need for paper or plaster by using a direct-applied, UV-cured acrylic coating layer of desired color (e.g., white). This coating layer is able to fill in the embedded mesh texture of the core composite panel structure, cures nearly instantaneously, and provides a durable, smooth, paint-ready surface. The result is a faster, more reliable, and lower-cost manufacturing process with superior product consistency and performance.

The composite wall panels (Generation III) of the disclosure include a core composite panel structure as described above to which a finish layer has been applied. The overall thickness of the composite wall panels can be selected to meet specified requirements and can be in a range of ¼ inch to 1 inch, preferably ⅜ inch to ¾ inch, and more preferably ½ inch to ⅝ inch.

The composite wall panels include a finish layer that comprises a curable resin applied to one or both sides of the core composite panel structure and that is caused or allowed to cure. The curable resin coating layer can serve as the final surface layer for the composite wall panels, replacing previously used laminated paper (Generation II) or plaster coatings (Generation I). The curable resin used to form the finish layer provides the following functions:
Surface leveling: can fill in surface depressions caused by the embedded fiberglass mesh of the core composite panel structure to produce a uniform, flat surface finish.
Durability: can provide a tough, resilient surface that resists impact and abrasion.
Moisture Resistance: can be fully non-porous and water-impermeable, eliminating the risk of mold or mildew growth.
Paintability: can offer a white or neutral-toned surface that readily accepts standard paints and coatings without the need for primer some cases.
Manufacturing Efficiency: can cure rapidly under ultraviolet (UV) light, enabling high-speed continuous production.

In some embodiments, the finish layer can be formed from a light-curable, UV-curable, and/or chemical-curable resin, examples of which include, but are not limited to, acrylic or methacrylic resins, aliphatic urethane acrylates, epoxy acrylates, polyester acrylates, and hybrids. An appropriate resin can be selected based on target hardness, flexibility, and adhesion properties. UV-curable resins include a photoinitiator to trigger polymerization upon UV exposure. Examples include, but are not limited to, benzoin ethers, acylphosphine oxides (e.g., diphenyl(2,4,6-trimethylbenzoyl) phosphine oxide, or TPO), and benzophenones depending on desired cure rate and depth. Alternatively, chemical cure resins known in the art can be used, such as the UV-curable resins mentioned above but which are modified to include a chemical initiator instead of, or in addition to, the photoinitiator. Examples of chemical initiators include peroxides (e.g., benzoyl peroxide), which are sometimes paired with an amine in a 2-part system, and cross-linkers.

In some embodiments, UV-curable coatings used to make the finish layer may comprise the following general components, with variations in exact percentages based on application needs:
Acrylic or Methacrylic Resins (20-90%)
They serve as the primary film-forming matrix. Options include aliphatic urethane acrylates, epoxy acrylates, polyester acrylates, and hybrids, selected based on target hardness, flexibility, and adhesion properties.
Reactive Diluents/Monomers (5-60%)
They control the viscosity and crosslinking density. Example include mono- and multifunctional acrylates or methacrylates, such as 1,6-Hexanediol diacrylate (HDDA), trimethylolpropane triacrylate (TMPTA), or ethylene oxide (EO)-modified monomers for flexibility.
Photoinitiators (0.5-10%)
They trigger polymerization upon exposure to UV radiation; can include benzoin ethers, acylphosphine oxides (e.g., TPO), or benzophenones depending on desired cure rate and depth.
Fillers and Extenders (5-35%)
They can be added to build film thickness, reduce gloss, improve surface durability, or adjust texture. Common options include calcium carbonate, fumed silica, aluminum silicate, or titanium dioxide.
Additives (0-5%)
They include optional defoamers, dispersants, adhesion promoters, or leveling agents to tailor flow and adhesion.

The selection of curable coating can be used to provide performance tunability. Table 1 lists desired properties and examples of how to achieve them.

TABLE 1

| Property | Basic Formulation Strategies |
|---|---|
| Gloss Level | Matte to high-gloss via resin and filler tuning |
| Hardness | From flexible to abrasion-resistant by resin |
| | crosslinking |
| Chemical Resistance | Enhanced via epoxy or urethane acrylates |
| Texture | Smooth standard; micro-textures possible with |
| | additives |
| Primer-Free | Tuned surface energy for compatibility with |
| Paintability | standard paints |

As discussed more fully below, in preferred embodiments, the basic manufacturing steps for a UV-curable resin may include:
Application: a curable resin is applied to a surface of the core composite panel structure by roller or curtain coater;
Film Thickness: targeted between 30-40 mils wet;
Cure Method: UV lamps (mercury vapor, LED, or excimer)
   Mercury: broad-spectrum
   LED: energy efficient, narrow-spectrum
Cure Time: Seconds (e.g., 1-10 seconds); no post-curing needed

The polymer finish layer can provide or impart the following surface functionality to the composite wall panels:
Seamless, mesh-free surface
Excellent adhesion to underlying cementitious layer
Paint-ready without skim coating and sanding; priming may be required depending on the level of finish required.
Mold and water resistance
Compatible with readily available tape and joint compound at edges

In some embodiments, it may be desirable to apply and process the polymer finish layer in a manner that provides what is known in the industry as “level 5” finish, or “drywall finish level 5”. A level 5 finish is defined by the Gypsum Association, the trade association for drywall professionals. The Gypsum Association has codified a set of professional standards that define the process of finishing drywall into five distinct levels. The following definitions are given for comparison. A level 0 finish means that no drywall finishing of any type has been done. At this level, the drywall boards are simply fastened to the walls or ceiling. A level 1 finish means that drywall joint tape has been embedded in the joint compound at the seams or joints, with no further finishing. A level 2 finish means that a skim coat of joint compound has been applied over the tape and to cover drywall screw holes. A level 3 finish means that a drywall finisher has applied a coat of joint compound to the tape and screws. Walls that will receive a heavy texture can end at this level, as progressing beyond this level of smoothness is unnecessary since texturing will produce a finish that is rougher than level 3. A level 4 finish is the classic drywall finish. This is achieved by applying another coat of joint compound to the tape and screws and sanding the dried compound. A level 4 finish is typically used when a surface is painted or covered with wallpaper. A level 5 finish is the highest possible level of drywall finishing and involves applying a skim coat, if applicable. A level 5 finish is achieved by applying another skim coat of joint compound (or mud) to a level 4 finish and then fine sanded. A level 5 finish is desirable when the applied finish will have glossy, enamel, or non-textured flat paint or when the light will be angled low enough to highlight bumps and depressions.

A level 5 finish is a premium finish that typically commands a much higher cost than lower level finishes. Providing a composite wall panel having a finish layer that already provides a level 5 finish can eliminate the many steps and time required to prepare ordinary drywall to have a level 5 finish. This saves labor costs and time, including the time required for each coat of joint compound to dry and then be sanded.

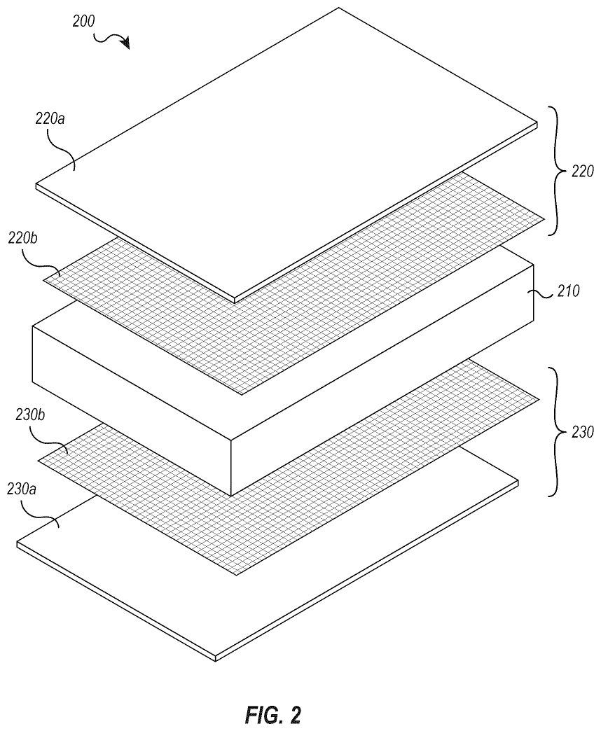

Reference is made to FIGS. 3-8B, which illustrate example embodiments of composite wall panels of the disclosure.

FIG. 3 illustrates the layered structure of an example composite wall panel 300. The composite wall panel 300 comprises the basic core composite panel structure, including a foam core 310 sandwiched between a first fiber mesh reinforced cementitious (or other protective) layer 320 and a second fiber mesh reinforced cementitious (or other protective) layer 330. A finish layer 340 is formed over the second fiber mesh reinforced cementitious (or other protective) layer 330, which forms the show side, i.e., that will be visible as the interior wall surface before applying a desired finish, such as paint and/or wallpaper. The finish layer 340 in this embodiment is shown as having a textured surface that provides the look of rough plaster. It will be appreciated that the finish layer 340 can have any desired surface finish, including smooth to very smooth, including a level 5 finish, which is a substantial improvement over traditional gypsum drywall panels.

The fiber mesh reinforced cementitious layers 320, 330 provide several advantages. The textured surface of the second fiber mesh reinforced cementitious layer 330 can enhance the bond strength of the finish layer 340 and prevent delamination. Because the first fiber mesh reinforced cementitious layer 320 does not include a finish layer it can have a textured surface that facilitates adhesion of the composite wall panel 300 to wall frame studs, ceiling joints, or other underlying structure using an adhesive or glue. In addition, the first and second fiber mesh reinforced cementitious (or other protective) layers 320, 330 provide high strength, which permits the composite wall panel 300 to support relatively heavy loads, such as pictures, television sets, or other appliances using nails or screws, particularly if they can penetrate through both the first and second fiber mesh reinforced cementitious (or other protective) layers 320, 330.

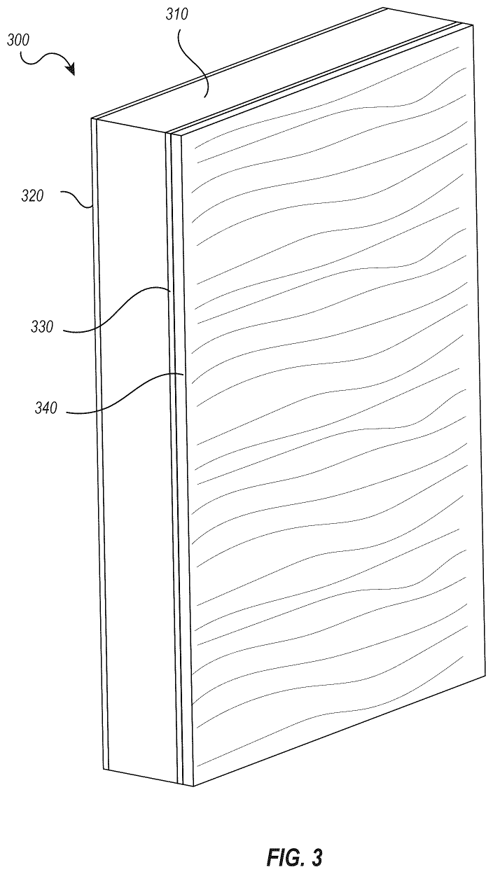

FIGS. 4A-4C illustrate another embodiment of a composite wall panel 400 made from a core composite panel structure with a smooth polymer finish layer formed over the exposed or show side. The composite wall panel 400 comprises the core composite panel structure, including a foam (e.g., polymer) core 410 sandwiched between first and second fiber mesh reinforced cementitious (or other protective) layers 420, 430. A finish layer 440 is formed over the second fiber mesh reinforced cementitious (or other protective) layer 430, which forms the show side that will be visible as the interior wall surface before applying a desired final finish, such as paint or wallpaper. The finish layer 440 in this embodiment has a smooth surface finish. It will be appreciated that the finish layer 440 can have any desired surface finish, including smooth to very smooth, including having a level 5 finish, which is a substantial improvement over traditional gypsum drywall panels.

The textured surface of the second fiber mesh reinforced cementitious (or other protective) layer 430 can enhance the bond strength of the finish layer 440, which prevents delamination. The first fiber mesh reinforced cementitious (or other protective) layer 420 can have a textured surface that facilitates adhesion of the composite wall panel 400 to wall frame studs, ceiling joists, or other underlying structure. The first and second fiber mesh reinforced cementitious (or other protective) layers 420, 430 provide high strength, which permits the composite wall panel 400 to support relatively heavy loads, such as pictures, television sets, or other appliances using nails or screws, particularly if they can penetrate through both the first and second fiber mesh reinforced cementitious (or other protective) layers 420, 430.

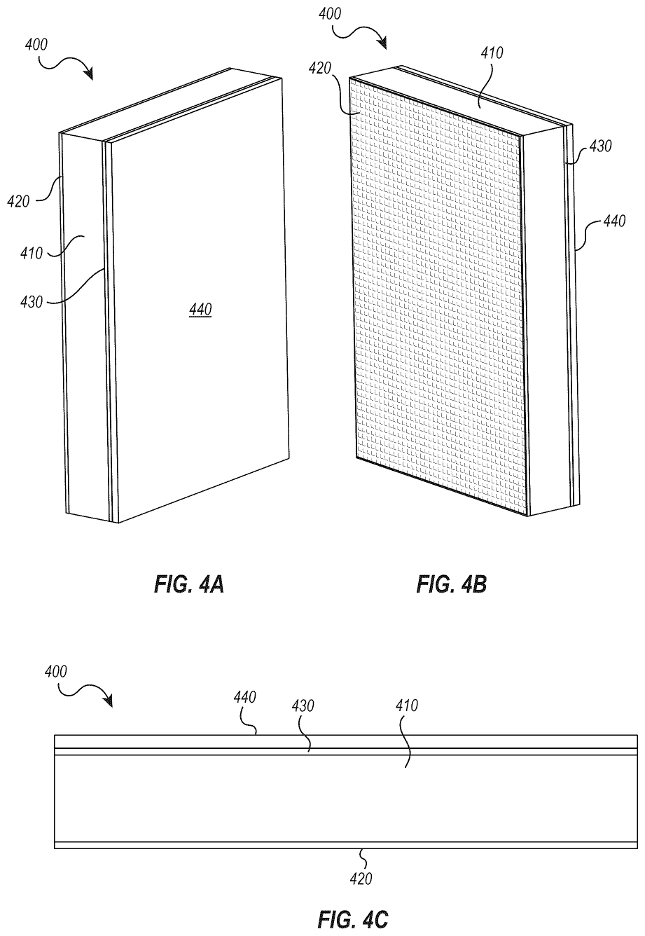

FIGS. 5-7B illustrate composite wall panels 500, 600, 700 having beveled edges. FIG. 5 schematically illustrates a composite wall panel 500 having four beveled edges 542, one in each of the four sides, and a finish layer 540 covering the entire upper surface, beveled edges 542, and side ends 546. The finish layer 540 over the beveled edges 542 can be applied over beveled portions of a fiber mesh reinforced cementitious layer (not shown) that extend over the foam core (not shown) in the region of the beveled edges 542 to provide the beveled edges 542 with a smooth finish and additional strength.

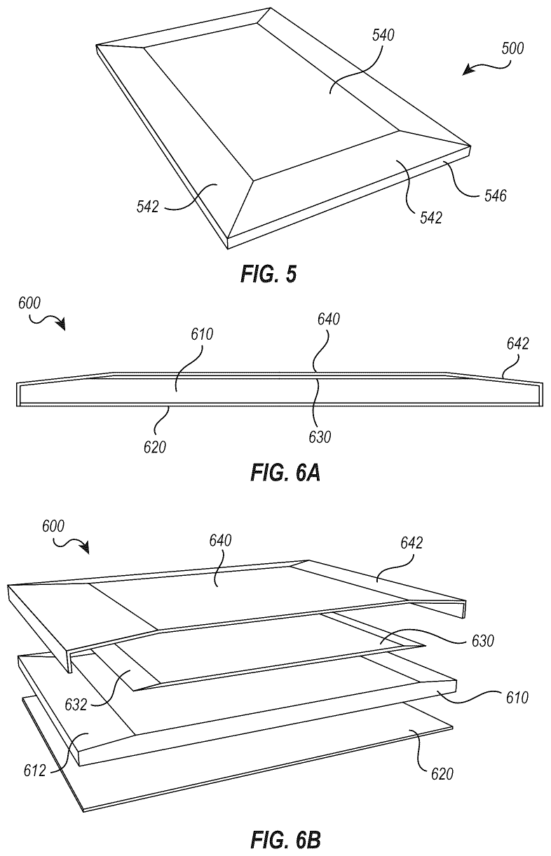

FIG. 6A is a side cross-sectional view, and FIG. 6B is an exploded view, showing the layered structure of an embodiment of a composite wall panel 600. As illustrated in FIG. 6A, the composite wall panel 600 includes a foam (e.g., polymer) core 610, a first fiber mesh reinforced cementitious (or other protective) layer 620 on an interior side, a second fiber mesh reinforced cementitious (or other protective) layer 630 on an exterior side, and a finish layer 640 formed over the second fiber mesh reinforced cementitious (or other protective) layer 630. The composite wall panel 600 includes beveled edges 642, with a beveled portion 612 of the foam core 610 being partially covered by a believed portion 632 of the second fiber mesh reinforced cementitious (or other protective) layer 630, which in turn is covered by a beveled portion of the finish layer 640. In this way, the beveled edges 642 can have similar strength as the non-beveled portion of the composite wall panel 600, which permits using nails, screws, or other fastening means to fasten the composite wall panel 600 to wall frame studs, ceiling joists, or other structural elements through the beveled edges 642.

FIG. 6B is an exploded view of the composite wall panel 600 that more particularly illustrates the layered structure. The composite wall panel 600 includes a polymer foam core 610, a first fiber mesh reinforced cementitious (or other protective) layer 620, which can include a first cementitious layer with embedded first fiberglass mesh (not shown), a second fiber mesh reinforced cementitious (or other protective) layer 630, which can include a second cementitious layer with embedded second fiberglass mesh (not shown), and a finish layer 640 formed over the second fiber mesh reinforced cementitious (or other protective) layer 630. The composite wall panel 600 also includes beveled edges 642, which includes a beveled portion 612 of the foam core 610 partially covered by a beveled portion 632 of the second fiber mesh reinforced cementitious (or other protective) layer 630, which are both covered by the beveled portion 642 of the finish layer 640.

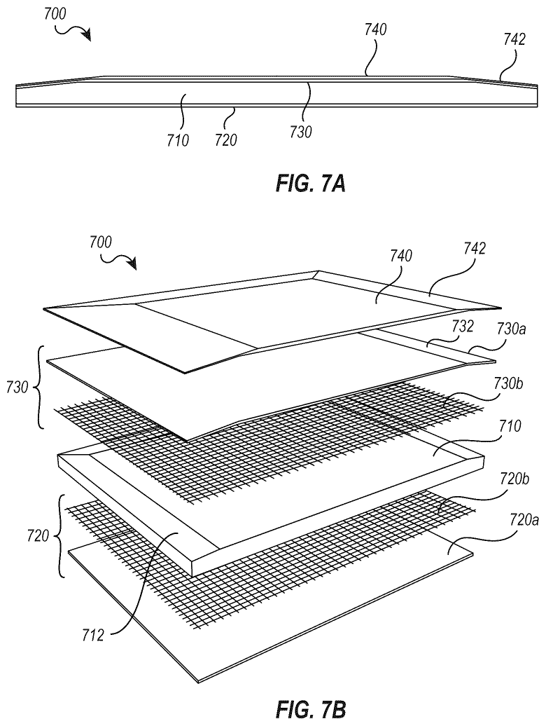

FIG. 7A is a side cross-sectional view, and FIG. 7B is an exploded view, showing the layered structure of another embodiment of a composite wall panel 700. As illustrated in FIG. 7A, the composite wall panel 700 includes a foam (e.g., polymer) core 710, a first fiber mesh reinforced cementitious (or other protective) layer 720 on an interior side, a second fiber mesh reinforced cementitious (or other protective) layer 730 on an exterior side, and a finish layer 740 formed over the second fiber mesh reinforced cementitious (or other protective) layer 730. The composite wall panel 700 includes beveled edges 742, with a beveled portion 712 of the foam core 710 being entirely covered by a beveled portion 732 of the second fiber mesh reinforced cementitious (or other protective) layer 730, which in turn is covered by a beveled portion 742 of the finish layer 740. In this way, the beveled edges 742 can have the same reinforcement and strength as the non-beveled portion of the composite wall panel 700, which permits using nails, screws, or other fastening means to fasten the composite wall panel 700 to wall frame studs, ceiling joists, or other structural elements through the beveled edges 742.

FIG. 7B is an exploded view of the composite wall panel 700 that more particularly illustrates the layered structure. The composite wall panel 700 includes a foam core 710, a first fiber mesh reinforced cementitious layer 720, which includes a first cementitious layer 720a with embedded first fiberglass mesh 720b, a second fiber mesh reinforced cementitious layer 730, which includes a second cementitious layer 730a with embedded second fiberglass mesh 730b, and a finish layer 740 formed over the second fiber mesh reinforced cementitious layer 730. The composite wall panel 700 also includes beveled edges 742, which includes a beveled portion of the foam core 710 entirely covered by a beveled portion of the second fiber mesh reinforced cementitious layer 730, which is entirely covered by a beveled portion of the finish layer 740.

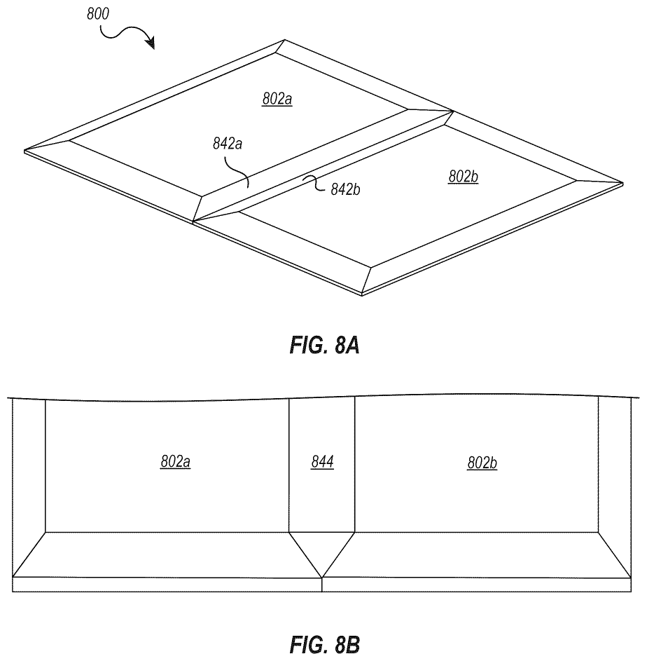

FIG. 8A illustrates two composite wall panels 800 positioned side-by-side and abutting each other, each having a finish layer 802a, 802b and beveled edges 842a, 842b that are aligned to facilitate application of tape and drywall patch to hide the seam and join the composite wall panels 800 together, as illustrated in FIG. 8B. FIG. 8A shows the beveled edges 842a, 842b covered by a portion of the finish layers 802a, 802b.

FIG. 8B illustrates two composite wall panels 800 positioned side-by-side and abutting each other, with beveled edges 834 aligned so as to permit the application of tape and drywall patch to join them together. FIG. 8B shows the beveled edges 834 filled in with wall filler 844 (e.g., drywall patch) such that the two composite wall panels 800 have been joined together to yield a finished, seamless surface finish 832. A level 5 finish can be achieved in a minimal number of steps by taping and plastering only the beveled edges 842a, 842b, followed by sanding the joint. Skim coating and sanding of the non-beveled portions of the finish layers 802a, 802b is not required if they already have a factory applied level 5 finish.

### C. Apparatus and Method for Making Composite Wall Panels

In the case where it is desired for the composite wall panels to have beveled edges, the first step is to form beveled edges in either the foam core or the core composite panel structure. FIGS. 7A-7B illustrate an embodiment in which the beveled edges can be formed in the foam core before forming the fiber mesh reinforced cementitious (or other protective) layer. Alternatively, FIGS. 6A-6B illustrate an embodiment in which the beveled edges can be formed in the core composite panel structure, which would remove a portion of the fiber mesh reinforced cementitious (or other protective) layer. In that case, the finish layer would be applied over the entire surface of the core composite panel structure, including portions that included or lacked the fiber mesh reinforced cementitious (or other protective) layer to form a finished composite wall panel.

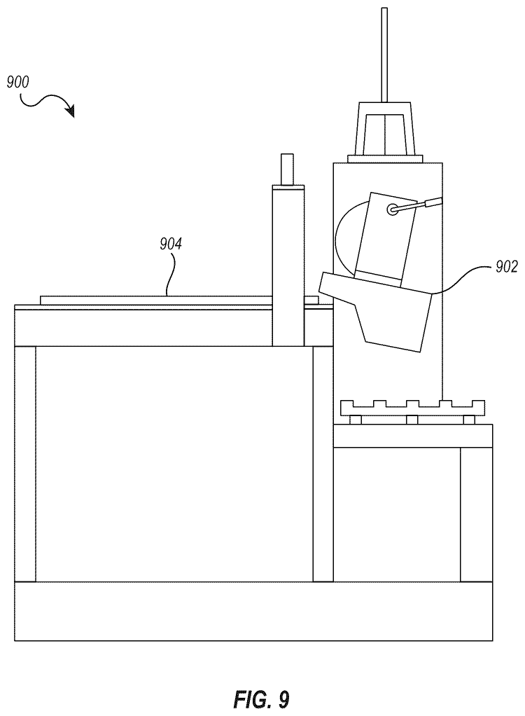

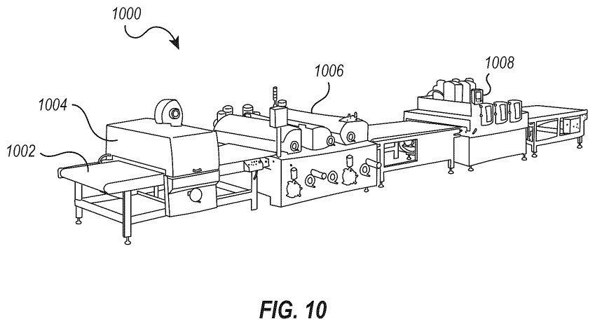

Reference is now made to FIGS. 9 and 10. FIG. 9 illustrates an example beveling apparatus 900 with a beveling tool 902 used to grind or cut bevels into the sides of a foam core 904 prior to sequentially applying the second fiber mesh reinforced cementitious layer and finish layer.

As illustrated in FIGS. 7A and 7B, the bevels can be formed in a core composite panel structure by removing a portion of the foam core 710 to form beveled regions 712, which can be covered by the second fiber mesh reinforced cementitious layer 730 to maximize strength in the beveled region 732, and then be covered by the finish layer 740 to form the finished beveled edges 742. Thus, the beveling apparatus can make beveled edges 712 in an uncoated side of the foam core 710, followed by applying the second fiber mesh reinforced cementitious layer 730 on the beveled side, which is allowed to at least partially harden, followed by applying the finish layer 740 over the second cementitious layer 730 to form composite layered beveled edges 742. The composite layered beveled edges 742 provide substantially greater strength for receiving screws, nails, or other mechanical fastening means known in the art.

FIG. 10 illustrates an example coating and curing system 1000 for applying and curing a UV-curable resin to at least one side of a core composite panel structure to form the finish layer. The coating and curing system 1000 as illustrated includes a conveyor 1002 and two or three zones, including an optional pre-cleaning zone 1004 to remove powder or other debris, an application zone 1006 for applying a UV-curable resin, and a curing zone 1008 for irradiating the UV-curable resin with ultraviolet (UV) light. The coating and curing system 1000 more particularly includes an application station 1006 for roller or curtain application of the UV-curable resin and a curing station 1008 for curing the UV-curable resin using UV radiation to form a finished composite wall panel with a cured polymer finish layer. In a preferred embodiment, the core composite panel structure to be coated is beveled on 2 to 4 edges (left and right edges, and optionally top and bottom edges), more preferably in which the beveled edges are covered by a fiber mesh reinforced cementitious layer.

To apply the UV-curable resin, the core composite panel structure is passed via the conveyor 1002 through the coating zone or station 1006 in which the UV-curable resin is applied (e.g., in liquid form) by roller or curtain application to at least a top side of the core composite panel structure, and optionally the side edges, to form an intermediate coated composite panel structure. The intermediate coated composite panel structure is then passed through the curing zone or station 1008, which exposes the UV-curable resin to ultraviolet (UV) light to harden the UV-curable resin and form the cured finish layer. The finish layer will be the exposed or show side of the composite wall panel that can be further covered with paint, wallpaper, or other surface finish to yield a finished wall. The finish layer advantageously fills in discontinuities, such as the mesh pattern of the fiber mesh reinforced cementitious (or other protective) layer, to yield a smooth surface to which a final surface finish can be subsequently applied. The optional pre-cleaning zone 1004, when included, can remove loose materials that might otherwise become embedded in the finish layer, possibly forming bumps, discontinuities, or other undesirable features rather than a desired smooth outer surface. In use, the underside of the composite wall panel may not be visible, as it is the surface facing the underlying wall or ceiling frame, and thus can remain uncoated. Moreover, the mesh or otherwise rough surface may be desirable to promote adhesion to an underlying wall or ceiling frame or other structural element.

The composite wall panels can be used to make interior walls in place of gypsum drywall. As discussed above, the composite wall panels include a core composite panel structure that includes a strong yet lightweight foam core sandwiched between two fiber mesh reinforced cementitious (or other protective) layers, but with an additional finish layer of cured polymer resin to provide a smooth surface having the appearance of plaster or skim coated drywall. The surface can be painted, wallpapered, and the like.

To summarize, the apparatus and method used to form the composite wall panels of the disclosure are characterized by the following:
1. Beveling: a bevel is added to the 4 edges of the foam core through a cutting process prior to coating with cement and fiberglass to form the core composite panel structure. In some embodiments, the bevel size can be approximately 2 mm×38 mm and is present on all 4 edges.
2. Coating: the UV-curable resin can be applied via roller or curtain coater.
3. Curing: UV lamps can be used to harden the resin instantly to form the finish layer.
4. Trimming: the composite wall panel edges and lengths can be finalized downstream by cutting or trimming.

The composite wall panels can provide the following features and benefits:

### Single-Step Finish

Eliminates plaster (Generation I) and paper (Generation II) surfaces;
Provides a factory-finished, paint-ready surface;
No glue, lamination, or sanding are required.

### Superior Durability

The composite wall panels are impact-, water-, and mold-resistant;
They include no cellulose and therefore do not promote organic growth;
They are resistant to chemical cleaners and abrasion.

### Lightweight and Easy to Handle

The composite wall panels are significantly lighter than gypsum drywall;
They can be cut with standard tools;
They are compatible with traditional fasteners.

### High Manufacturing Throughput

Continuous flow process;
Minimal quality variation;
Lower labor requirements.

### Potential Applications

Interior wall and ceiling systems;
Modular construction/panelized builds;
Bathrooms, basements, flood-prone areas;
Healthcare and hospitality interiors;
High-performance airtight building envelopes.

The following is a summary of important aspects and advantages of the composite wall panels disclosed herein:

### Composite Wall Panel System

Includes the core composite panel structure having a polymer (e.g., XPS) foam core sandwiched between fiber mesh-reinforced cementitious (or other protective) layers;
Also include a UV- and/or chemical cured surface coating or finish.

### Coating Composition and Functionality

Acrylic-based UV- and/or chemical-curable formulation;
Fills mesh depressions in the fiber mesh-reinforced cementitious layer;
Paintable, waterproof, and mold-resistant.

### Manufacturing Process

Continuous flow: i) beveling; ii) coating; iii) curing; and iv) sizing.

### Performance Enhancements

Smooth finish without plaster or paper;
Faster, more consistent production;
High surface durability and compatibility with other finishing systems.

### Uses

Interior walls, ceilings, wet areas, modular buildings.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A composite wall panel, comprising:
a core composite panel structure comprised of:
a foam core having a first surface and a second surface opposite the first surface; and
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core; and
a finish layer at least partially covering at least one side of the core composite panel structure, wherein the finish layer comprises a light-cured, UV-cured, and/or chemical-cured polymeric material.

2. The composite wall panel of claim 1, wherein at least one of the first or second fiber reinforced cementitious layers is included and comprises fiber reinforcement embedded within a hardened cementitious composition formed from a fresh cementitious composition comprising mixture products of water, Portland cement, silicon dioxide, calcium oxide, and gypsum hemihydrate.

3. The composite wall panel of claim 2, wherein the fiber reinforcement is selected from fiber mesh, alkali-resistant fiberglass mesh, embedded fibers, fabric, woven, scrim, felt, and non-woven, wherein the fiber reinforcement comprise at least one of plant fibers, polymer fibers, and inorganic fibers, which are selected from fibers or filaments formed from glass, basalt, rock wool, or carbon.

4. The composite wall panel of claim 2, wherein the fresh cementitious composition comprises mixture products of water, hydraulic cement, silicon dioxide, calcium oxide, iron oxide, gypsum hemihydrate, water-reducing agent, defoamer, styrene, and acrylic acid or polymer thereof, optionally at least one supplementary cementitious material (SCM) selected from the group consisting of ground granulated blast furnace slag (GGBFS), fly ash, natural pozzolan, silica fume, microsilica, metakaoline, ground glass, calcined clay, and finely ground quartz, and optionally at least one of natural hydraulic lime, calcium silicate, or expanded glass.

5. The composite wall panel of claim 2, wherein the fresh cementitious composition comprises mixture products of:

| | |
|---|---|
| hydraulic cement | 30-50% |
| silicon dioxide | 40-60% |
| calcium oxide | 2-5% |
| iron oxide | 0.2-1% |
| gypsum hemihydrate | 3-8% |
| water-reducing agent | 0.2-0.6% |
| defoamer | 0.2-0.6% |
| styrene | 1-2% |
| acrylic acid | 1-2% |
| water | 15-22% |
| | of dry ingredients. |

6. The composite wall panel of claim 2, wherein at least one of the first or second fiber reinforced cementitious layers has a cross-sectional thickness in a range of about 0.5 mm to about 3 mm, or about 0.75 mm to about 2.5 mm, or about 1 mm to about 2 mm, or about 1.25 mm to about 1.75 mm.

7. The composite wall panel of claim 2, wherein the first and second fiber mesh reinforced cementitious layers provide a textured surface having depressions and ridges, wherein the finish layer at least partially fills in the depressions and at least partially covers the ridges to yield a surface finish selected from a smooth planar finish or a textured finish.

8. The composite wall panel of claim 1, wherein at least one of the first or second thermoset polymer layers is included and comprises polyurea or polyaspartic and is optionally fiber-reinforced.

9. The composite wall panel of claim 8, wherein the at least one of the first or second thermoset polymer layers has a cross-sectional thickness in a range of about 1 mm to about 5 mm, or about 2 mm to about 4 mm.

10. The composite wall panel of claim 1, wherein the finish layer is formed from a UV-curable composition comprising mixture products of acrylic resin, acrylic monomer, filler and/or pigment, and initiator, or mixture products of 30% to about 90% by weight of one or more acrylic resins, about 10% to about 40% by weight of one or more acrylic monomers, about 10% to about 35% by weight of one or more fillers and/or pigments, and about 1% to about 10% by weight of one or more initiators.

11. The composite wall panel of claim 1, wherein the composite wall panel includes at least 2 beveled edges, with the core composite panel structure including at least 2 beveled edges and the finish layer covering the beveled edges of the core composite panel structure.

12. The composite wall panel of claim 11, wherein the beveled edges of the core composite panel structure include beveled edges in the first side of the foam core, and wherein the first protective layer covers an entirety of the first side of the foam core, including the beveled edges.

13. The composite wall panel of claim 1, wherein at least a portion of the finish layer has a smooth surface, optionally a level 5 finish.

14. The composite wall panel of claim 1, wherein the composite wall panel includes a single finish layer, wherein a side of the composite wall panel opposite the single finish layer has a textured surface.

15. The composite wall panel of claim 1, wherein the foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure.

16. The composite wall panel of claim 1, wherein the foam core comprises an inorganic foam material selected from the group consisting of silica gel, aerogel, silicate foams, urea-silicate foams, foams that include or are derived from silicate-rich minerals, foams based on perlite, foams based on spherical perlite, foams based on vermiculite, SiOC/SiC, ceramic foams, and refractory foams.

17. A composite wall panel, comprising:
a core composite panel structure comprised of:
a polymer foam core having a first surface and a second surface opposite the first surface;
a first protective fiber mesh reinforced cementitious layer formed over and covering at least a portion of the first surface of the polymer foam core; and
a second protective fiber mesh reinforced cementitious layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein each of the first and second protective fiber mesh reinforced cementitious comprises fiberglass mesh embedded within a hardened cementitious composition comprising reaction products of a fresh cementitious composition comprising water, Portland cement, silicon dioxide, calcium oxide, and gypsum hemihydrate; and
a finish layer at least partially covering at least one side of the core composite panel structure, wherein the finish layer comprises a light-cured, UV-cured, and/or chemical-cured polymeric material.

18. A composite wall panel, comprising:
a core composite panel structure comprised of:
a polymer foam core having a first surface and a second surface opposite the first surface;
a first protective thermoset polymer layer formed over and covering at least a portion of the first surface of the polymer foam core; and
a second protective thermoset polymer layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein the first and second thermoset polymer layers are independently selected from polyurea and polyaspartic and are optionally fiber-reinforced; and
a finish layer at least partially covering at least one side of the core composite panel structure, wherein the finish layer comprises a light-cured, UV-cured, and/or chemical-cured polymeric material.

19. A method of manufacturing a composite wall panel as in claim 1, comprising:
providing the core composite panel structure;
forming the finish layer over at least one side of the core composite panel structure, wherein the finish layer is formed by applying a curable resin in a flowable state to at least one side of the core composite panel structure; and
causing or allowing the curable resin to cure to form the finish layer.

20. The method of claim 19, wherein the core composite panel structure is manufactured by:
providing the foam core having the first and second sides;
applying a first fiber mesh sheet to the first side of the foam core and a second fiber mesh sheet to the second side of the foam core;
applying a first quantity of a fresh cementitious composition to the first side of the foam core so as to at least partially embed the first fiber mesh sheet within the first quantity of fresh cementitious composition;
applying a second quantity of the fresh cementitious composition to the second side of the foam core so as to at least partially embed the second fiber mesh sheet within the second quantity of fresh cementitious composition; and
allowing the fresh cementitious composition to harden and form the first and second fiber mesh reinforced cementitious layers.

21. The method of claim 19, wherein the finish layer comprises or is formed from a UV-curable resin, the method comprising:
applying the UV-curable resin in flowable state to at least the first fiber mesh reinforced cementitious layer;
and exposing the UV-curable resin to ultraviolet (UV) light to harden the UV-curable resin.

22. The method of claim 21, wherein the UV-curable resin is applied by at least one of roller application or curtain application.

23. The method of claim 19, further comprising forming beveled edges in the core composite panel structure by forming beveled edges in the first side of the foam core before or after forming the first and second protective layers, the finish layer covering the beveled edges.
